(19) United States
(12) Patent Application Publication
(10) Pub. No.: US 2007/0273583 A1
(43) Pub. Date: Nov. 29, 2007

(54) POINTING INTERFACE FOR PERSON-TO-PERSON INTERACTION THROUGH AD-HOC NETWORKS

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: OUTLAND RESEARCH, LLC, Pismo Beach, CA (US)

(21) Appl. No.: 11/619,607

(22) Filed: Jan. 3, 2007

Related U.S. Application Data
(63) Continuation-in-part of application No. 11/344,612, filed on Jan. 31, 2006.
(60) Provisional application No. 60/774,777, filed on Feb. 17, 2006.
(60) Provisional application No. 60/717,591, filed on Sep. 17, 2005.
(60) Provisional application No. 60/759,530, filed on Jan. 17, 2006.

(51) Int. Cl. H04B 7/00; G01S 5/14

(52) U.S. Cl. 342/367; 342/357.08

(57) ABSTRACT

The present invention comprises methods and apparatus that enable a user of a portable computing device to selectively communicate with other users of portable computing devices while those devices are engaged in an ad-hoc network. More specifically, the present invention enables a first user of a first portable computing device to gain information about and/or send a message to a second user of a second portable computing device by pointing a portion of the first portable computing device at the then current physical location of the second user. In this way a first user of a first portable computing device may naturally and conveniently select a second user of a second portable computing device from among a plurality of users of other portable computing devices engaged in an ad-hoc network and selectively gain information about the second user and/or send a message to the second user.

### RELATED APPLICATION DATA

This application claims priority to provisional application Ser. No. 60/774,777, filed Feb. 17, 2006, the disclosure of which is hereby incorporated by reference herein in its entirety; this application is a continuation-in-part of co-pending U.S. patent application Ser. No. 11/344,612, filed on Jan. 31, 2006, which claims priority to U.S. Provisional Application Ser. No. 60/717,591; the present application also claims priority to provisional application Ser. No. 60/759,530, filed Jan. 17, 2006, the disclosure of which is hereby incorporated by reference herein in its entirety. The present application is also related to co-pending provisional patent application 60/680,699, filed on May 13, 2005, and 60/707,909, filed on Aug. 12, 2005, both of which are by Louis B. Rosenberg, the present inventor, and both of which are hereby incorporated by reference.

### FIELD OF THE APPLICATION

The present invention relates to mobile social networking applications that track the location of a plurality of users of portable electronic devices and enable information exchange between users and/or person-to-person communication between users.

### BACKGROUND

Mobile social networking systems are generally operated as managed services by application service providers (“ASPs”) and operate using several common characteristics. For example, users typically create unique personal profiles that include basic information including age, gender, user name, interests, profession, history, testimonials and information about their network. In some applications, users map their relationship with other members, either by inviting other members to join their network (e.g., Friendster™ and/or Linkedin™), or by using software to scan existing relationships recorded in computer contact software (e.g., Spoke™ and/or Visible Path™). Most commonly, these applications provide such functions as friend-finding, text-dating and community message aggregation. Friend-finder applications (e.g., Dodgeball™) can identify the location of the user and the friend of a user and alert the user when the friend is within certain proximity. Such applications may also consult the relationship map and identify “friends of friends” who have announced they are within a certain range of the user's vicinity. Text-dating applications (e.g., MobiVibe™) allow users to connect with new friends who meet age and gender criteria, enabling users to communicate, e.g., to exchange text messages. Community message aggregators (e.g., Upoc™) distribute messages from one member to all members within a specific community. A system disclosed in pending U.S. Patent Application Publication No. 2005/0177614, the disclosure of which is hereby incorporated by reference, enables like-minded mobile device users to meet one another, on a permission basis, based upon one or more factors such as: each user's reciprocal networking objective, the nature of the industry in which the user works, the user's level within the management hierarchy of his or her company, any specialty function the individual may possess, and so on. A similar system that is constructed for use within Bluetooth networks and other peer-to-peer networking configurations is disclosed in pending U.S. Patent Application Publication No. 2005/0174975, the disclosure of which is hereby incorporated by reference.

A problem with current mobile social networking systems is that they do not allow a user to gain information about and/or initiate communication with another user (or group of users) by simply pointing at the then current location of that user (or group of users). Such a pointing method would be highly desirable because it offers a convenient and intuitive way by which a user may identify another user in his or her immediate vicinity for person-to-person information exchange even if the user does not know the name, phone number, or other unique identifier for that other user.

### SUMMARY

The present invention enables a user of a first portable computing device to request information about and/or initiate communication with a user of a second portable computing devices by pointing a portion of the first portable computing device in the direction of the second portable computing device. The first and second portable computing devices are engaged in an ad-hoc network between them using an ad-hoc networking technology within each. In general, a plurality of portable computing devices may be engaged in one or more ad-hoc networks between them at a given time. Embodiments of present invention thereby allow a user of a first portable computing device to select a user of a second portable computing device from among a plurality of users of plurality of available portable computing devices engaged in the ad-hoc networks. For example, a plurality of portable computing devices equipped with Bluetooth networking capability may be within certain proximity of each other (e.g., ten meters) such that they automatically form and maintain one or more ad-hoc Bluetooth networks among them.

By using embodiments of the present invention, a user of a first of the plurality of plurality of portable computing devices may request information about and/or initiate communication with the user of a second of the plurality of portable computing devices by pointing a portion of the first portable computing device in the direction of the user of the second portable computing device. In one preferred embodiment, the user of the first portable computing device must also engage a user interface element of the first portable computing device when the first portable computing device is desirably aimed. For example, the user interface element may be a button, trigger, lever, or switch. The user interface element may also be a voice command issued to a voice recognition system. In addition, embodiments of the present invention enable each user of each portable computing device to establish a personal profile upon his or her portable computing device. The data within the personal profile of each portable computing is used by to enable and/or limit the ability of a first user of a first portable computing device to request information about and/or initiate communication with a user of a second portable computing device.

The above summary of the present invention is not intended to represent each_embodiment or every aspect of the present invention. The detailed description and figures will describe many of the embodiments and aspects of the present invention.

### BRIEF DESCRIPTION OF THE DRAWINGS

The above and other aspects, features and advantages of the present embodiments will be more apparent from the following more particular description thereof, presented in conjunction with the following drawings wherein:

FIG. 1 illustrates a plurality of portable computing devices that are used by a plurality of users and configured such that one or more wireless ad-hoc networks form among and between them when they are brought within a certain proximity according to at least one embodiment of the invention;

FIG. 2 illustrates a portable computing device configured with appropriate hardware and software according to at least one embodiment of the invention;

FIGS. 3 and 4 illustrate an operation for portable computing device users to access information about one another and/or initiate communication with one another according to at least one embodiment of the invention;

FIGS. 5a-5d illustrate sensor readings according to at least one embodiment of the invention;

FIG. 6 illustrates a portable computing device equipped with a GPS sensor for tracking its position and one or more orientation sensors for tracking its direction as aimed by a user according to at least one embodiment of the invention; and

FIG. 7 illustrates a portable computing device aimed by a targeting user in a particular direction according to at least one embodiment of the invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

Embodiments of the present invention enable portable computing device users to engage in person-to-person communication and/or information access through an inventive process that involves targeting other users by pointing a portion of their portable computing device at the physical location of those other users. More specifically, embodiments of the present invention enable users of portable computing devices that are connected to each other by an ad-hoc communication network to engage in person-to-person communication and/or person-to-person information exchange by pointing at the physical location of one and other. As used herein, “portable computing device” should be broadly construed as including any mobile wireless client device, e.g., a cell phone, pager, a personal digital assistant (PDA, e.g., with GPRS NIC), a mobile computer with a smart phone client, or the like. The portable computing devices according to embodiments of the present invention are equipped with a wireless networking technology that enables them to automatically form and maintain ad-hoc networks with other such devices within certain proximity. A variety of wireless ad-hoc network technologies may be employed, although for the purposes of this disclosure Bluetooth networking technology is used as the enabling example technology.

The portable computing devices of embodiments of the present invention may also include additional forms of wireless communication. A typical portable computing device is a wireless access protocol (“WAP”)-enabled device that is capable of sending and receiving data in a wireless manner using the wireless application protocol. WAP allows users to access information via wireless devices, such as mobile phones, pagers, two-way radios, communicators, and the like. WAP supports wireless networks, including Cellular Digital Packet Data (“CDPD”), Code Division Multiple Access (“CDMA”), Global System for Mobile communication (“GSM”), Personal Digital Cellular (“PDC”), Personal Handyphone System (“PHS”), Time Division Multiple Access (“TDMA”), FLEX, ReFLEX, Integrated Digital Enhanced Network (“iDEN”), Terrestrial Trunked Radio (“TETRA”), Digital Enhanced Cordless Telecommunications (“DECT”), DataTAC, and Mobitex, and it operates with many handheld device operating systems, such as PalmOS, EPOC, Windows CE, FLEXOS, OS/9, and JavaOS. Typically, WAP-enabled devices use graphical displays and can access the Internet (or other communication network) on so-called mini- or micro-browsers, which are web browsers with small file sizes that can accommodate the reduced memory constraints of handheld devices and the low-bandwidth constraints of a wireless networks. In a representative embodiment, the mobile device is a cellular telephone that operates over General Packet Radio Service (“GPRS”), which is a data technology for GSM networks. In addition to a conventional voice communication, a given mobile device can communicate with another such device via many different types of message transfer techniques, including short message service (“SMS”)), enhanced SMS (“EMS”), multi-media message (“MMS”), email WAP, paging, or other known or later-developed wireless data formats. In an illustrated embodiment, mobile device users use SMS, which is a text message service that enables short messages (e.g., generally no more than 140-160 characters in length) to be sent and transmitted from a portable computing device. Embodiments of the present invention are not limited to mobile device users who have WAP-enabled devices or to use of any particular type of wireless network. Such devices and networks are merely illustrative; any wireless data communication technology now known or hereafter developed may be used in connection with the invention that is now described in more detail.

To enable the inventive features of the present invention, specialized software runs upon each portable computing device, moderating the pointing-enabled person-to-person communication features and functions. Such an application may take a wide variety of forms and is hereby called a person-to-person communication application (“PPCA”). Each of the portable computing devices is also configured with a locative sensor by which the device may receive or derive coordinate data that indicates the current spatial location of that portable computing device within a the real physical world. While a number of locative sensor technologies may be used to support the present invention, the present disclosure references Global Positioning System (“GPS”) transducers as enabling examples of such a locative sensor. Each of the portable computing devices is also configured with an orientation sensor such that its pointing orientation may be tracked in real-time. While a number of orientation sensor technologies may be used to support the present invention, Magnetometer transducers are referenced herein as enabling examples of such orientation sensors. Each of the portable computing devices is also equipped with a wireless peer-to-peer networking technology and configured such that the portable computing devices will automatically form ad-hoc networks amongst themselves when brought within a certain proximity. While a range of peer-to-peer networking technologies may be used to support the present invention, the embodiments described herein reference Bluetooth as the enabling example of such a technology. Thus, embodiments of the present invention may be viewed as a plurality of Bluetooth-enabled portable computing devices that are configured to automatically form ad-hoc networks amongst themselves when brought within certain proximity. In some embodiments the certain proximity is ten meters.

As described herein, the PPCA running upon each of the plurality of portable computing devices of embodiments of the present invention is operative to exchange locative data with other of the plurality of portable computing devices when the devices form an ad-hoc network between them. For the PPCA running upon each portable computing device, the exchange process has two part—(i) reading a current locative sensor on board the portable computing device (or interfaced to the portable computing device) and sending locative data representing the current sensor readings to the other of the plurality of portable computing devices, and (ii) receiving locative data from each of the other of the plurality of portable computing devices along with unique identifying data for each and storing a representation of the locative data in local memory. The data stored in local memory generally includes data representing the current spatial locations of one or more other portable computing devices along with a unique identifier for each of the devices. A time history of locative data for each may also be stored.

Thus, when a portable computing device according to the present invention comes within a certain proximity of another portable computing device according to the present invention, one or more ad-hoc networks are formed among them and locative data is automatically and repeatedly exchanged between them along with unique identifier information. In this way each of the portable computing devices creates and repeatedly updates a local data store (referred to herein as a “Local Locative Database”) that includes a representation of the current location of one or more other of the portable computing devices in the local spatial environment. In some embodiments the Local Locative Database also includes a time-history of recent locations of other portable computing devices. Furthermore, in some embodiments the PPCA application may be operative to predict a current location of a particular portable computing device based at least in part upon the stored time-history of previous locations of that portable computing device. Furthermore, in some embodiments the PPCA application may be operative to predict a current location of a particular portable computing device based in part upon a velocity derived from the stored time-history of previous locations of that portable computing device and/or based upon velocity data received from that portable computing device over the ad-hoc network.

The PPCA application running upon each portable computing device may also be operative to store and selectively access a unique personal profile for the current user of that portable computing device. The unique personal profile may include personal information such as the age, gender, name, interests, profession, political affiliations, organizational affiliations, school affiliations, team affiliations, job title, marital status, sexual orientation, height, weight, highest level of education, IQ, music preferences, sports team preferences, dietary preferences, hobbies, income, and/or fitness level for each user. The PPCA application may also be operative to store information about each user's friends and/or business associates in their social network, maintaining a map or other storage of their personal relationships with other users. Such information, whether personal or business related, is referred to herein as “social networking information.” The PPCA application may also be operative to store access-preference information for each user, the access-preference information describing and/or limiting how other users may gain information about and/or initiate communication with that user. For example, access-preference information may limit access to some or all personal information for a particular user only to other users who match certain criteria, possess certain characteristics, and/or meet certain security requirements. Similarly, access-preference information may limit communication with a particular user only to other users who match certain criteria, possess certain characteristics, and/or meet certain security requirements. In some embodiments the certain security requirements includes a particular user possessing a password or satisfying some other authentication. In some embodiments the certain criteria includes a particular user being a member of a particular network of friends or business associates. In some embodiments the certain characteristics includes a particular user having a certain combination of demographic characteristics. Personal profile information and/or personal security and/or privacy parameters may be stored in some embodiments on a remote server that is accessible by the portable computing devices over a communication network such as the Internet. In such embodiments the personal profile information for each user and/or each portable computing device is indexed by a unique identifier associated with that user and/or portable computing device.

The determination as to whether a first user accesses information about and/or initiates communication with a second user depends upon the first user targeting the second user by pointing at least a portion of his or her mobile computing device at the current physical location of the second user. The determination of whether the first user accesses information about and/or initiates communication with the second user and/or the extent of the information that the first user may access about the second user, may also be dependent upon (i) privacy and/or security parameters established by the second user and stored upon his or her portable computing device or a remote server, (ii) personal profile parameters and/or identification parameters established by the first user and stored upon his portable computing device or a remote server, and/or (iii) social networking data associated with the first user and/or second user and stored upon his or her personal computing device and/or remote server. The determination of whether the first user accesses information about and/or initiates communication with the second user and/or the extent of the information that the first user may access may also be dependent upon one or more specific demographic traits associated with the first user and/or the second user, the personal demographic traits including but not limited to data reflecting the age, gender, occupation, sexual orientation, height, weight, income, IQ, highest level of education, political party, personal interests, group memberships, school affiliations, company affiliations, team affiliations, job title, level of corporate hierarchy, and/or marital status of that user, and/or any combination of the aforementioned factors. The determination of whether the first user may access information about and/or initiate communication with second user may also be dependent upon the second user providing user input through the user interface of his or her portable computing device to explicitly authorize information access and/or communication initiation when an attempt is made by the first user through the pointing method.

Embodiments of the present invention may be implemented as a computer system that facilitates business and/or social networking activities by and among portable computing device users. In one embodiment, portable computing device users use a Web browser (on a computer or the portable device itself) to register online for a managed service that is provided by a system operator who administers the system and manages information accesses and/or communication initiations between registered portable computing device users. In particular, the system operator may run a remote server that maintains data about the users to regulate information access and/or communication initiation. The data optionally includes personal profile information, access-preference information, and/or social networking information. The information may be supplied by (or derived from) the respective portable computing device users during the registration process and/or during subsequent interactions with the server. The information may include, but is not limited to, personal identification information, personal accessibility preferences, personal password information, and/or personal demographic information that may include but is not limited to the user's stated age, gender, occupation, sexual orientation, height, weight, income, IQ, highest level of education, political party, personal interests, group memberships, school affiliations, company affiliations, team affiliations, job title, level of corporate hierarchy, and/or marital status. The profile data may also include a list of access preferences that describes and/or lists the users and/or user qualities and/or user demographic characteristics and/or social networking characteristics that may be granted access to information or authorized to initiate conversation with the user. An example registration process is disclosed in pending U.S. Patent Application Publication No. 2005/0177614, the disclosure of which is hereby incorporated by reference.

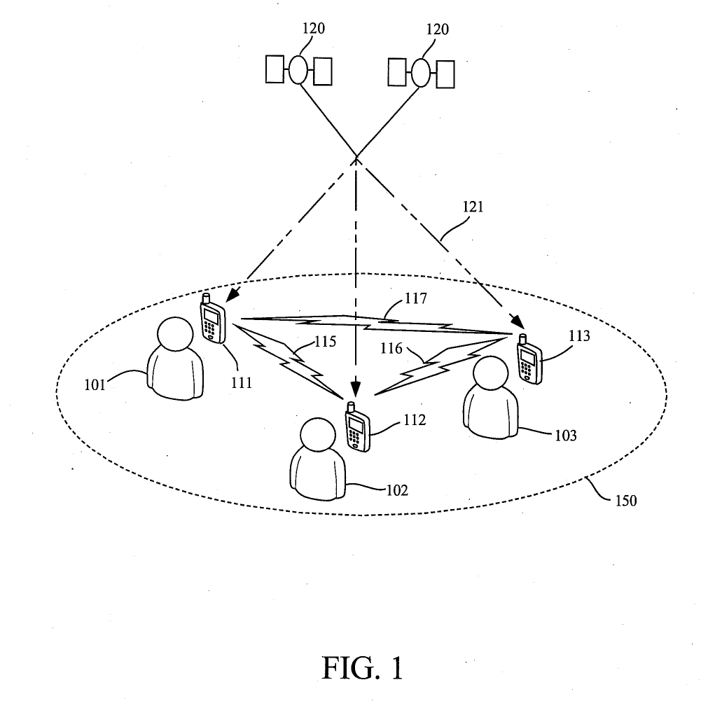

FIG. 1 illustrates a plurality of portable computing devices 111, 112, and 113 that are used by a plurality of users 101, 102, 103 and configured such that one or more wireless ad-hoc networks form among and between them when they are brought within certain proximity using, for example, a Bluetooth networking technology, according to at least one embodiment of the invention. In this example embodiment, the ad-hoc network is represented by wireless communication links 115, 116, and 117. As shown, the ad-hoc network of this example enables each portable computing device to communicate directly with each other portable computing device within certain proximity. For standard Bluetooth of the current art, the proximity is generally ten meters. To make the proximity limitations clear, a proximity circle is represented by dotted line 150 such that all devices within the dotted line are sufficiently proximal to each other to be automatically engaged in an ad-hoc communication network. It In some embodiments the ad-hoc network may include multiple layers such that some devices cannot communicate directly with other devices, but instead can exchange information through an intervening device. Such a multi-layered ad-hoc network may be used in accordance with embodiments of the present invention to expand the range of the network. For example, in a crowded area such as a city street, bus station, dance club, or school, the area covered by a multi-layer ad-hoc network may far exceed the size of a single peer to peer network connection. For simplicity of explanation the discussed herein describes embodiments of the invention with respect to a single layer ad-hoc network with the understanding that the size may be expanded through the use of multiple layers.

Referring back to FIG. 1, each portable computing device according to an embodiment of the invention includes a locative sensor, and orientation sensor, a wireless communication connection, and the ability to form, join, maintain, and otherwise participate in an ad-hoc network with other similar devices. The locative sensor may take a variety of forms but often includes a GPS sensor. The GPS sensor accesses a set of overhead satellites 120 to accurately determine a current spatial location within the physical world for that portable computing device. In some preferred embodiments the GPS sensor is integrated within or upon the portable computing device although it may also be a peripheral that is interfaced with the portable computing device. Because the portable computing device is generally kept on the person of the user of that portable computing device, the location of the portable computing device and the location of the user of the portable computing device are generally referred to herein interchangeably to mean the same thing.

The orientation sensor within each portable computing device may take many forms so long as it provides an absolute pointing direction for the portable computing device when at least an aiming portion of that portable computing device is pointed in a particular direction. In many embodiments the orientation sensor is a magnetometer that detects orientation with respect to the earth's magnetic field. In some embodiments only the planar orientation with respect to magnetic north is determined. In other embodiments an elevation angle may also be determined. In the most general case roll, pitch, and yaw angles may be determined to fully describe the orientation of the portable computing device at a current moment in time.

In one example embodiment a three-axis magnetometer model number HMC1023 manufactured by Honeywell SSEC of Plymouth, Minn. is included. This sensor produces x, y and z axis signals. In addition, some embodiments may include a gyroscope such as a 1-axis piezoelectric gyroscope model number ENC-03 manufactured by Murata Manufacturing Co., Ltd. of Kyoto, Japan to further sense changes in orientation of the portable computing device. Other sensors can provide orientation information. For example, an accelerometer may be included to provide tilt orientation information about the portable computing device in one or two axes. In some embodiments a single axis accelerometer is used that senses the pitch angle (i.e., tilt away from horizontal) that the portable computing device is pointing. In other embodiments a 2-axis accelerometer can be used that senses the pitch angle that the portable computing device is pointing as well as the roll angle (i.e., left-right tilt) that the portable computing device is pointing. A suitable accelerometer is model number ADXL202 manufactured by Analog Devices, Inc. of Norwood, Mass.

In general the locative and orientation sensor(s) are housed within the casing of the portable computing device and are connected electronically to the microprocessor of the portable computing device such that the microprocessor can access sensor readings and perform computations based upon and/or contingent upon the sensor readings.

As discussed above, a PPCA runs upon each of the plurality of portable computing devices 111, 112, 113 according to an embodiment of the present invention. One function of the PPCA running upon each portable computing device is to automatically exchange locative data with other of the plurality of portable computing devices when the devices form an ad-hoc network between them. Thus, in the present example, devices 111, 112, and 113 are configured by the PPCA to repeatedly communicate their current locative position (as locative data) to each of the other of the portable computing devices over the ad-hoc network. In some embodiments current orientation data is also communicated. In some embodiments current velocity data is also communicated. In all embodiments a unique identifier is also communicated such that the data received may be relationally associated with a particular portable computing device (or a particular user of that portable computing device) by the unique identifier.

Thus, the PPCA running upon each portable computing device is operative to read a current locative sensor on board the portable computing device (and optionally a current orientation sensor and/or velocity sensor) and then communicates locative data (and optionally orientation data and/or velocity data) representing the current sensor readings to the other of the plurality of portable computing devices. This step is generally performed repeatedly at a sufficient rate such that the data transmitted is substantially current. There will always be a time lag associated with data transmissions, but in general the time lag is kept sufficiently small that the data is substantially current and effectively represents the current position (and optionally orientation and/or velocity) of the transmitting portable computing device. In some embodiments the repeated reading and sending of data is performed at a regular rate. In other embodiments the repeated reading and sending of data is dependent upon a change or rate of range of the locative data itself. For example, the update rate may be increased if the locative data is changing at a rapid rate and/or the update rate may be slowed if the locative data is not changing or changing at a slow rate. Such inventive variable update rate methods are described in more detail below.

In addition to sending locative data (and optionally orientation data and/or velocity data) to other portable computing devices within certain proximity over the ad-hoc network, the PPCA running upon each portable computing device is also operative to receive and process locative data from each of the other of the plurality of portable computing devices. In general the data is received along with unique identifying data for each, thereby enabling the data to be relationally associated with the unique identifier. The PPCA application is operative to receive such data and store a representation of such data in local memory. The data stored in local memory generally includes data representing the current spatial locations of one or more other portable computing devices along with a unique identifier for each of the devices. A time history of locative data for each may also be stored. As discussed above, the local data store upon each portable computing device is referred to herein as the Local Locative Database. This database is repeatedly updated as new data is received by the portable computing device from other portable computing devices. The database may include historic data. In such embodiments a time-stamp is generally stored along with the received data, the time-stamp indicating the time at which the data was collected, sent, and/or received.

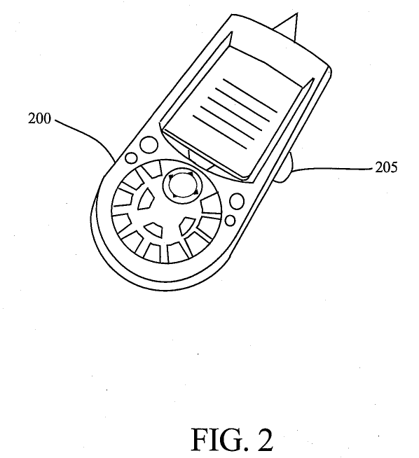

FIG. 2 illustrates a portable computing device 200 configured with appropriate hardware and software according to at least one embodiment of the invention. As shown, the portable computing device 200 includes basic telephone features such as a dial pad and a handset configuration with microphone and speaker. The portable computing device 200 includes a computer processor, an information display, a user interface, and a wireless communication link to an information network such as the Internet. The portable computing device 200 also has a short range wireless communication means for forming ad-hoc networks with other devices within certain proximity. In many embodiments Bluetooth is used to support this functionality although other wireless communication methods could be used. The portable computing device 200 also includes a differential GPS transceiver for sensing the current geographic location of the portable computing device. The portable computing device may further include one or more orientation sensors such as a magnetometer for sensing geometric orientation with respect to geographic north and an accelerometer for sensing pitch angle of the device with respect to the gravitational horizontal. Moreover, the portable computing device 200 is shaped such that it can be conveniently pointed at one or more other users by the user. Thus, the portable computing device 200 includes a user aiming portion that may be conveniently pointed in the direction of another user. The portable computing device 200 also includes or more targeting and ranging methods and/or technologies for targeting one or more other users when aimed by the user. For example, portable computing device 200 may include an optical lens, a laser pointer, an ultrasonic sensor, a laser rangefinder, a digital camera, and/or a pair of stereo digital cameras. The portable computing device 200 also includes a user interface component such as a button, knob, switch, lever, or trigger that the user manipulates so as to indicate that the portable computing device is then currently aimed at a desired target user.

The user of the portable computing device 200 aims the device at another user using one or more targeting methods and technologies described herein. For example, a targeting device such as digital camera or integrated laser pointer may be used as is described in more detail below. Automatic ranging hardware such as an ultrasonic sensor or laser rangefinder is optionally included. The user aims the targeting device at a desired distant user (or group of users) and presses a button (or other user interface) upon the portable computing device 200 to indicate that the device is currently aimed. The software running upon the portable computing device 200 then computes a targeting vector, targeting coordinate, and/or targeting distance for the targeted user (or group of users). The targeting vector is derived in whole or in part using the magnetometer which gives an orientation vector with respect to magnetic north. The direction may also include a pitch angle with respect to the gravitational horizontal. This pitch angle can be derived from the sensor data collected from an on board accelerometer (or other tilt sensor). The targeting distance is derived in one of a number of ways. It can be estimated by the user controlling a user interface such as a ranging knob or slider. It can be computed using a ranging sensor such as an ultrasonic transducer or a laser rangefinder. The distance magnitude can be a single value or a range of acceptable values as specified by the user. The targeting and/or ranging information is then used by the PPCA to identify (or estimate) the targeted user(s) based upon location information of current users stored in the Local Locative Database. This process is described in more detail below. Once the targeted users(s) are identified by the PPCA, the unique identifier for the targeted portable computing device(s) and/or the user(s) of the targeted portable computing devices is accessed and person-to-person communication may be initiated subject to conditional limitations. In general the conditional limitations are dependent upon personal profile information, personal security information, personal access preferences, and/or other personal data stored within either or both of the targeting portable computing device and targeted portable computing device.

The PPCA server subsequently determines, based upon the information, whether the targeting user is authorized to access information about and/or initiate communication with one or more of the targeted users. If the targeting user had requested information about a targeted user and is determined to have access to that information, the information is transmitted by the PPCA server to the portable computing device of the targeting user. The information is then displayed to the targeting user by the visual and/or audio display features of the portable computing device. If the targeting user had requested communication with a targeted user and is determined to have communication initiation access authorization with that targeted user, the PPCA running upon both devices enables communication from the targeting user to the targeted user.

Because a user may wish to target a particular person in an environment filled with a plurality of persons and because GPS and other sensors have limited accuracy and resolution, an important aspect of embodiments of the present invention is the ability to target distant user(s) that are within certain proximity of a targeting vector and/or targeting coordinate. This is achieved by defining or otherwise specifying an angular range around a targeting vector and/or a distance range around a targeting coordinate within the limits of which a targeted user will be identified by the PPCA. In this way targeting accuracy limitations can be accommodated for. In some preferred embodiments the user can set the angular range values and/or distance range values by accessing a menu driven interface upon the portable computing device.

Embodiments of the present invention enable users of a portable computing device to engage in person-to-person communication and/or information access through an inventive process that involves targeting other users by pointing a portion of their portable computing device at the physical location of those other users.

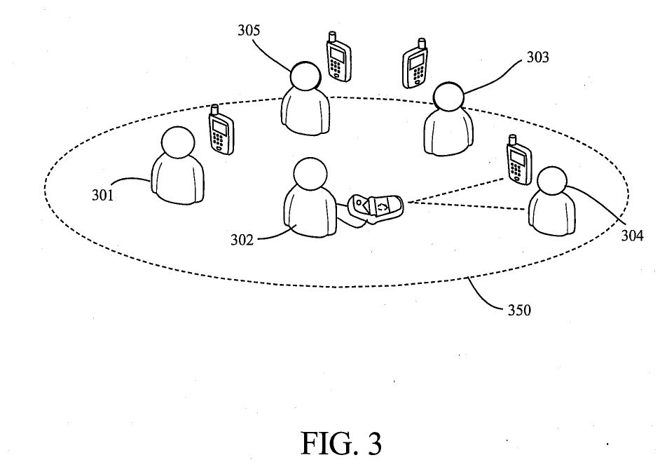

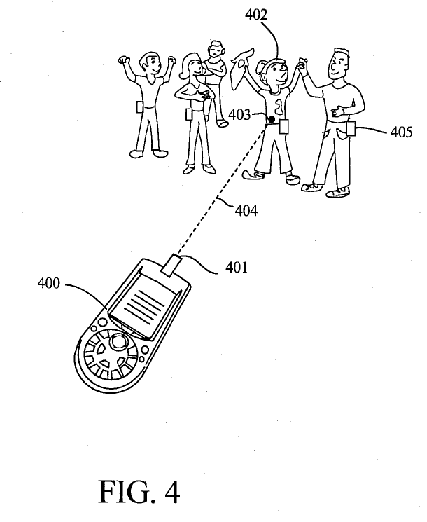

FIGS. 3 and 4 illustrate an operation for portable computing device users to access information about one another and/or initiate communication with one another according to at least one embodiment of the invention. The portable computing device users access information about one another and/or initiate communication with one another, preferably on a permission basis, by a first of the users pointing their portable computing device (or a portion thereof) at a second of the users. As illustrated in FIG. 3, when a first portable computing device user 302 targets a second portable computing device user 304 by aiming his portable computing device (or a portion thereof) at the current physical location of the second portable computing device user 304 at a current moment in time, the PPCA running upon the first portable computing device 302 determines which device (if any) is being pointed at and then by exchanging information with the targeted device, whether the first user is authorized to access information about the second user and/or whether the first user is authorized to initiate communication with the second user. The determination is based upon one or more of a plurality of different factors. Some of these factors are based upon personal profile information, access-preference information, and/or social networking information stored for the first user and/or the second user upon their respective devices and/or upon a remote server. Other of the factors may also include the second user explicitly authorizing information access and/or communication initiation by responding in real-time to a prompt displayed upon his or her portable computing device. The prompt to the second user may include, for example, a visual or audio or tactile alarm imparted by the second user's portable computing device get the second user's attention as well as a visual and/or audio prompt indicating that another user has requested information access and/or requested communication initiation. The prompt may provide the first user's name, ID, handle, or other identifier. The prompt may also provide the second user with demographic information and/or social networking information about the first user. The prompt may also provide the second user with spatial information about the location of the first user relative to the second user. For example, a graphical map or pointer may be displayed that indicates the relative location of the first user with respect to the second user, depicting the relative direction and/or direction in which the first user currently resides.

As shown in FIG. 3, the PPCA application running upon portable computing device 302 is operative to receive locative data from a plurality of portable computing devices within a certain proximity, including devices 301, 303, 304, and 305. The PPCA application is also operative to send locative data to each of the devices. In this way each of the devices maintains a Local Locative Database that includes information describing the current spatial locations of the other of the devices. Thus, referring specifically to portable computing device 302, the PPCA application running upon it receives and stores data from each of the other portable computing devices in a Local Locative Database. The data includes but is not limited to current positional coordinates for each of the portable computing devices, the positional coordinates describing or otherwise indicating the substantially current geographic location of each portable computing device. Because it is assumed that the portable computing devices are kept local to its user (i.e., held, worn, or otherwise carried about by a user), the positional coordinates are also assumed to describe or otherwise indicate the substantially current geographic location of each of the users of the devices.

The PPCA application is also operative to monitor the user input to portable device 302. In this embodiment the user input being monitored is a button upon the device. The user aims the device as shown and presses the button. Upon detecting the button press, the PPCA application reads the orientation sensor on board portable computing device 302. The PPCA application also reads the position sensor on board the portable computing device 302. These values present the location and orientation of the aiming direction of portable computing device 302. These values are then used by the PPCA application along with the data stored in the Local Locative Database to determine whether the user of portable computing device 302 has successfully targeted one or more of the plurality of portable computing devices by virtue of being aimed at the geographic location of that one or more other of the plurality of portable computing devices while its user engages an appropriate user interface function (i.e., presses the button). The PPCA is further operative to determine if the first user is authorized to access information about the second user and/or if the first user is authorized to initiate communication with the second user. The PPCA is further operative to moderate the subsequent information exchange between users and/or the subsequent communication initiation between users if such exchange and/or communication is authorized.

In the particular example shown in FIG. 3, the PPCA application determined based upon the current position and orientation of portable computing device 302 and based upon the current position of the plurality of other portable computing devices 301, 303, 304, and 305, that the user of portable computing device 302 has targeted the user of portable computing device 304. The PPCA is then operative to determine whether the user of portable computing device 302 is authorized to access information about the user of portable computing device 304 and/or if the user of 302 is authorized to initiate communication with the user of 304. The PPCA is further operative to moderate the subsequent information exchange between users of 302 and 304 and/or the subsequent communication initiation between user of 302 and 304 if such exchange and/or communication is authorized.

The process of determining whether a first user successfully targets a second user and further determining whether the first user is authorized to access information about and/or initiate communication with the second user is referred to herein as a “targeting determination.” The PPCA application running upon the targeting portable computing device makes the targeting determination based upon a number of computational steps.

In one example embodiment, the procedure follows four basic operational steps as discussed below. The first step is the transmission of current positional coordinates from each of a plurality of portable computing devices 301, 303, 304, 305 to the targeting portable computing device 302. The current positional coordinates represent the then current geographic location of each of the portable computing devices. The current positional coordinates are stored by the PPCA of the targeting portable computing device in accessible memory and indexed such that each current positional coordinate is linked to the specific portable computing device and/or specific user from which it was received. By “current geographic location” it is understood that there will generally be some amount time lag that causes the most currently received and stored location for a particular user/portable computing device to actually reflect a location of that user/portable computing device at a recent time in the past. It is therefore desirable for embodiments of the invention to keep such time lags as small as possible within the practical limitations of the technology employed. This means frequent updates of current positional coordinates are sent between each portable computing devices. In some embodiments this is achieved by having all portable computing devices update their location at a rapid rate such as 30 to 100 times per minute. In other embodiments an intelligent algorithm is employed such that the update rate from each portable computing device is determined based upon the then current motion of that portable computing device. In such an algorithm, a portable computing device that is determined to be substantially at rest for a period of time will report infrequent updates of its location to other portable computing devices within the ad-hoc network, while a portable computing device that is determined to be in motion will report more frequent updates of its location to other portable computing devices within the ad-hoc network. The more rapid the motion of the portable computing device is, the more frequent the reporting will be.

In one such embodiment each portable computing device runs an Intelligent Reporting Algorithm upon a local processor. The Intelligent Reporting Algorithm accesses data from local positional and/or motion sensors and determines, based upon such data, whether the portable computing device is in motion and, if so, the current rate of motion. For example, in one such embodiment the Intelligent Reporting Algorithm upon each portable computing device accesses data from GPS sensors local to each portable computing device at regular rapid intervals and computes based upon a time history of such data, a current velocity estimation for the portable computing device in one or more directions. The Intelligent Reporting Algorithm then determines a reporting rate of positional data to the other portable computing devices in the ad-hoc network based upon the current velocity estimation. If the velocity estimation is zero because a user is, for example, sitting or standing still, a slow reporting rate will be determined such as, for example, one report every two minutes. If the velocity estimation is high because the user is, for example, walking or running, a fast reporting rate will be determined such as, for example 100 to 400 reports per minute. By dynamically adjusting the reporting rate from each portable computing device based upon the currently estimated velocity of that portable computing device, the method helps to better utilize available communication bandwidth, providing rapid reports from those user that require rapid reports for accurate tracking and infrequent reports from those users that do not require rapid reports for accurate tracking.

Some embodiments of the present invention enable each portable computing device to report its current velocity estimation to other portable computing devices along with its current positional coordinates during some or all updates. The velocity reports are used by the PPCA of each portable computing device in such embodiments to account for time-lag by providing through an inventive Predictive Tracking Algorithm in which a more accurate current location of a portable computing device is predicted based upon its reported current location (which is subject to time lag) and the reported velocity estimation associated with that reported current location. The Predictive Tracking Algorithm computes the more accurate current location of a portable computing device by adding a predictive spatial offset to the reported current location of that portable computing device, the predictive spatial offset being computed based upon the reported velocity estimation and the known or estimated time lag between the report and the current time. For example, if (a) a portable computing device reports its current location as X,Y,Z in some units U; (b) that portable computing device reports its current estimated velocity in units of U/sec to be Vx in the X direction, Vy in the Y direction and Vz in the Z direction; (c) it is known (or estimated) that a (t) second time lag is present between the time when the data was collected by the PPCA of one portable computing device and the current time the data is being processed by the PPCA of another portable computing device; then (d) a more accurate current location can be predicted by adding an offset equal to the estimated current velocity V multiplied by known or estimated time lag (t) as follows: (X+Vx t), (Y+Vy t), (Z+Vz t).

To support accurate time lag computations or estimations, some embodiments of the present invention enable portable computing devices to also report a time-stamp value to other portable computing devices along with the report of current positional coordinates. The time-stamp value indicates or otherwise represents the time at which the current positional coordinate was collected. This value is then used by the PPCA of each portable computing device to determine the time lag between when the most recently current positional coordinate was reported from a given portable computing device and the then current time at which targeting computations are being performed. In this way the PPCA of a particular portable computing device can know how up to date each positional coordinate is when performing a targeting determination. In this way the PPCA of a particular portable computing device can also more effectively account for time-lag using a predictive algorithm such as the one described above.

Thus, some embodiments of the present invention are configured such that each portable computing device reports to each of the other enabled portable computing devices within a local ad-hoc network, its most current positional coordinates, its most current velocity estimation, a time-stamp indicating when the positional coordinates were collected, and unique identifier enabling the PPCA of the receiving portable computing device to correlated the received data with a particular portable computing device and/or particular user. Some or all of this data is then stored in a local locative database for each of the portable computing devices. In some embodiments in which the portable computing device does not report a time stamp, the PPCA of the receiving portable computing device may be configured to store its own time-stamp for data received, the time-stamp indicating the time at which a current positional coordinate was received from a particular portable computing device. Such a time-stamp is generally not as accurate as one generated by a reporting portable computing device itself for there may be communication and processing delay that is not accounted for, but using this method reduces the amount of information that need be communicated over the communication link and therefore helps preserve communication bandwidth.

In some embodiments of the present invention the PPCA application running upon each portable computing device also stores a time-history of current geographic locations for each of the plurality of other enabled portable computing devices within the ad-hoc network. The time-history reflects one or more previous but recent locations of each of the plurality of portable computing devices. Furthermore, in some embodiments the PPCA application running on each portable computing device may be operative to predict a current location of one or more other portable computing devices based at least in part upon the stored time-history of previous locations of that portable computing device such as, for example, by deriving a velocity from the stored time-history of previous locations of that portable computing device and computing an offset based upon the derived velocity and a known or estimated time lag. For example, if (a) the PPCA application running on a particular portable computing device receives a current location from another portable computing device as X,Y,Z in some units U; (b) the PPCA running on a particular portable computing device computes an estimated current velocity for that other portable computing device based upon a time-history of stored location data for that other portable computing device; (c) if the estimated current velocity (V) in units of U/sec are determined to be Vx in the X direction, Vy in the Y direction and Vz in the Z direction; (d) if it is known (or estimated) that a (t) second time lag is present between the time when the data was collected and the current time the data is being processed by the PPCA of the receiving portable computing device; then (e) a more accurate current location can be predicted by adding an offset equal to the estimated current velocity V multiplied by the time lag (t) as follows: (X+Vx t), (Y+Vy t), (Z+Vz t).

Thus, in the first step of the targeting determination process, there are a variety of ways in which the PPCA application of a particular portable computing device may receive and store positional data from each of a plurality of other computing devices engaged in a current ad-hoc network, the positional data including current positional coordinates for the other portable computing devices and optionally including velocity data and/or time-stamp data and/or historical data for the other portable computing devices. This step is repeatedly performed at a rapid rate such that the PPCA of a particular portable computing device receives repeatedly updated and substantially current data about the location of the plurality of portable computing devices. The second, third, and forth operational steps of the present invention are related to the specific targeting operation performed by a first user of a first portable computing device (i.e., device 302) when seeking to gain information about and/or initiate communication with one or more other users (in this example, the second user of portable computing device 304). These steps are generally performed in response to a user targeting another user using his or her portable computing device. The first user initiates the targeting operation by aiming his or her portable computing device (or a portion thereof) at the then current visible location of the second user while engaging a user interface option upon his or her portable computing device. The steps which are then performed are as described below.

For clarity, the user who is pointing his or her portable computing device at other portable computing devices is referred to as the “targeting user” and his or her portable computing device is referred to as the “targeting portable computing device.” Similarly, the portable computing device that is being targeted by another portable computing device is referred to herein as the “targeted portable computing device.” Thus in FIG. 3, portable computing device 302 is the targeting portable computing device and portable computing device 304 is the targeted portable computing device at that particular moment in time. With that context, the steps to be performed by the PPCA of a targeting portable computing device are discussed below.

The second step is the reading of position and orientation sensors local to the targeting portable computing device in response to the user of that device initiating a targeting operation. The position and orientation sensors include, for example, a GPS sensor and other orientation sensors such as an accelerometer and/or magnetometer. The reading of the sensors provides a positional coordinate and orientation direction for the targeting portable computing device as positioned by the user during the targeting operation. In one preferred embodiment the portable computing device is a handheld unit that can be freely aimed by the user at one or more other users within a local space, such as local space 350 in FIG. 3. A variety of aiming tools and methods may be employed such as a laser pointer or a displayed image from a digital camera with overlaid crosshairs is described in further detail below. When the targeting portable computing device is aimed at a target user and/or a group of target users, the user presses a button, performs a gesture, utters a word or phrase, or otherwise indicates to the targeting portable computing device that it is desirably aimed at one or more targeted users. Based upon the button press or other indication by the user that the device is aimed as desired, the PPCA running upon the targeting portable computing device reads the position and orientation sensors to determine current positional coordinates and current orientation vector for that portable computing device. This completes the second step.

The third step is the determination of targeting vector(s), targeting distance(s) and/or targeting coordinate(s) for the target user and/or group of target users as defined by the aiming of the portable computing device by the targeting user. The targeting itself is likely performed by the first user using one or more inventive targeting tools and/or targeting methods (to be described later). A targeting vector is determined as an angular vector originating at the current positional coordinates of the targeting portable computing device and pointing in the direction that the portable computing device was aimed during the targeting action. A targeting distance is determined as a distance away from the current positional coordinates of the targeting portable computing device. A targeting coordinate is a spatial coordinate representing the targeted location of a target user as determined by adding an offset to the current positional coordinates of the first user. The offset is in a direction defined by a targeting vector and of a distance defined by a targeting distance. In some embodiments of the present invention, one or more range values is also used for each targeting operation, the range values including one or more of an angular range value or a distance range value. An angular range value defines a range of acceptable angles around a targeting vector, for example +/−5 degrees, within which a targeted user may reside. A distance range value is a range of acceptable distances around a targeting coordinate, for example +/−10 feet, within which a targeted user may reside. In some embodiments a plurality of range values may be computed for a plurality of different directions, including for example a minimum value and a maximum value. Finally, it should be noted that a plurality of targeting vectors, targeting distances and/or target coordinates may be determined during a particular targeting operation if a plurality of users are identified by the targeting user.

In some embodiments a targeting distance is not used. Instead, only a targeting vector is used along with the current positional coordinates of the targeting portable computing device. The targeted user is then identified as the nearest user (i.e., nearest portable computing device) to the targeting portable computing device along the direction (or approximately along the direction) defined by the targeting vector.

The forth step is a determination by the PPCA of the targeting portable computing device based upon the targeting vector(s), optional targeting distance(s) and/or targeting coordinate(s), which users (i.e., which portable computing devices) are being targeted and whether or not the first user can access information about the targeted user(s) or initiate communication with the targeted user(s). The forth step has a number of sub-steps as discussed below.

In sub-step (A), the PPCA of the targeting portable computing device identifies each of the targeted user(s) based upon their current geographic location as stored within the Local Locative Database on that portable computing device. This identification step may follow a number of different computational processes. In one computational process the PPCA computes an offset from the current positional of the targeting user in the direction of a targeting vector and determines the one or more users (i.e., portable computing devices) that reside on or near the line defined by the targeting vector. In an alternate computational process the PPCA computes an offset from the current positional of the targeting user along the direction of a targeting vector and determines the one or more users that reside within an angular range (e.g., a wedge shaped area) around the targeting vector. In an alternate computational process the process the PPCA server computes an offset from the current positional of the targeting user along the direction of a targeting vector and determines the one or more users that reside on or near the line defined by the targeting vector AND that is nearest in spatial distance from the targeting user. In an alternate computational process the PPCA server computes an offset from the current positional of the targeting user along the direction of a targeting vector by a distance equal to a targeting distance and determines the one or more users that reside on or near the point defined by the offset. In an alternate computational process the PPCA server computes an offset from the current positional of the first user along the direction of a targeting vector by a distance equal to a targeting distance and determines the one or more users that reside within a targeting range of the point defined by the offset. In some such embodiments the targeting range is an area or volume around that point.

Thus, in various embodiments a mathematical line, area, or volume is projected away from the targeting user in the direction of the targeting vector and a mathematical computation is performed by the PPCA of the targeting portable computing device to determine one or more other portable computing devices that reside upon, near, or within the projected line, area, or volume. In some such embodiments the nearest portable computing device that resides upon, near, or within the projected line, area, or volume is selected by the PPCA as the targeted portable computing device.

In sub-step (B) the PPCA accesses information about each of the target users determined in sub-step (A), the information including for example personal profile information, social networking information, and/or access preference information. The information may be accessed directly from the targeted portable computing device over the ad-hoc network or may be accessed by an alternate communication means from a remote server.

In sub-step (C) the PPCA server determines based upon the information accessed in sub-step (B) whether or not the targeting user is authorized to access information about one or more of the targeted users and/or whether or not the targeting user is authorized to initiate communication with one or more of the targeted users. This determination is dependent upon whether or not the targeting user requested information about one or more targeted users, requested communication initiation with one or more targeted users, or both. This determination may also be dependent upon one or more targeted users explicitly granting permission.

For embodiments that require permission of one or more targeted users, the PPCA communicates with each of such targeted portable computing devices over the ad-hoc network and causes the portable computing device to alert the users of those devices (by visual, audio, or tactile alarm) of the request and prompt them to grant or deny permission. In many such embodiments the PPCA also sends certain information about the targeting user to each of such targeted portable computing devices. The targeted portable computing devices may display the certain information about the targeting user such that the users can review the information as they decide whether to grant or deny permission. For example, the PPCA of a targeting portable computing device may be configured to communicate demographic data such as the age, gender, school affiliation, company affiliation, political party information, and/or marital status to each of such targeted portable computing devices. Such information is displayed to each of the targeted users by their respective portable computing devices such that they can consider such information when granting or denying permission. Similarly, the PPCA of a targeting portable computing device may be configured to communicate social networking data that describe one or more friendship relationships and/or business relationships of the targeting user to each of such targeted portable computing devices. Such information may be displayed to each of such targeted users by their respective portable computing device such that they can consider such information when granting or denying permission. Similarly, the PPCA of the targeting portable computing device may be configured to communicate peer-rating data for the targeting user to each of the targeted portable computing devices. This information reflects the satisfaction and/or dissatisfaction that other users expressed as a result of such previous interactions. Such peer-rating information may be displayed to each of the targeted users by their respective portable computing device such that they can consider such information when granting or denying permission. Similarly, the PPCA server may be configured to communicate user popularity data for the targeting user to each of the targeted portable computing devices. Such user popularity information is displayed to each of such targeted users by their respective portable computing device such that they can consider such information when granting or denying permission.

According to sub-step (D), the authorized information is accessed by the PPCA of the targeting portable computing device from the targeted portable computing device over the ad-hoc network if it is determined in sub-step (C) that the targeting user is authorized to access information about one or more of the targeted users. If it is determined that the targeting user is authorized to initiate communication with one or more targeted users, the PPCA enables communication initiation with the one or more targeted users over the ad-hoc network. This may be achieved by the PPCA of the targeting portable computing device interacting with the PPCA of a portable computing device to initiate voice, video, and/or text data transfer in a peer-to-peer communication configuration. In some embodiments this is achieved in whole or in part by the PPCA of the targeted portable computing device sending a phone number, email address, instant messaging address, alias, or other unique identifier about the targeted user (or targeted portable computing device) to the targeting portable computing device so that the targeting user can initiate communication over an alternate communication network. In some embodiments this is achieved in whole or in part by the PPCA of the targeting portable computing device sending a phone number, email address, instant messaging address, alias, or other unique identifier about the targeting user (or targeted portable computing device) to the targeted portable computing device so that the targeted user can initiate communication over an alternate communication network.

In some embodiments a step may be included wherein the targeting user selects from among a plurality of targeted users, which user or users he or she desires to initiate communication with. In some such embodiments the targeting user receives information about a plurality of targeted users, the information including for example personal profile information and/or social networking information and is provided the ability to review some or all of such information on this display of his or her portable computing device. Based upon such a review, the targeting user is enabled a selection process by which he or she, based upon the review of information about each of a plurality of targeted users, selects which of the plurality of users the targeting user wants to communicate with.

In many embodiments, a user when targeted by another user may accept or decline the communication by interacting with the user interface upon his or her portable computing device.

With respect to user registration, a portable computing device user registers for the service provided by embodiments of the present invention. Typically the user is prompted to fill database fields providing personal and/or professional details including, without limitation, age, gender, marital status, interests, highest level of education, school affiliation, team affiliation, political party affiliations, hobbies, business affiliation, job description, industry of employment, management hierarchy level, music preferences, sports team preferences, country of residence, city of residence, state of residence, city of birth, state of birth, country of birth, and the like. The user also outlines the profile and/or characteristics of people the user would like to interact with through the service and/or people the user would not like to interact with through the service.

A significant aspect of embodiments of the present invention is the ability of a user of a portable computing device to target a user (or group of users) that they are directly viewing and gain information about that user (or group of users) and/or initiate communication with that user (or group of users) are a result of successful pointing. As described herein, the hardware employed by the current invention to enable such person-to-person pointing-based interactions incorporates position sensors such as GPS transducers that track the geographic location of the portable computing devices they are carried about by each of the users. As also herein the hardware employed by the current invention incorporates orientation sensor technologies such magnetometers and accelerometers that track the orientation of the portable computing devices, the orientation indicating the direction that a portable computing device (or a portion thereof) is pointing as held by the user during a targeting action. The magnetometer and accelerometers can determine the spatial orientation with respect to magnetic north as well as the spatial orientation with respect to the downward direction due to gravity. In this way the software running upon the portable computing device can determine not only where the user is in the world (based upon position data collected by the GPS sensors) at particular points in time, but also what direction the user is pointing at (based upon orientation sensor data) as the user manipulates the portable computing device (or a portion thereof) and aims it at a desired remote target. This action by the user of aiming the portable computing device (or a portion thereof) at a particular user (or group of users) is referred to herein as Targeting and generally involves the user pressing a button or otherwise manipulating a user interface to indicate that the portable computing device is desirably aimed at a target user (or group of users).

To support such embodiments, a number of additional inventive methods and apparatus may be included to enable a user to accurately aim the portable computing device (or a portion thereof) at a particular user (or group of users) and press a button (or otherwise manipulate the user interface) to indicate that the portable computing device is then desirably aimed at a particular user about whom information should be accessed and/or with whom communication should be initiated. This is because it may be difficult for a user to know with a high degree of accuracy how well he or she is aiming the portable computing device (or a portion thereof) at a particular user (or group of users) that is some distance away from where the user is standing. Moreover, there may be many potential target users in close proximity, only one of whom a user may desire to target. To satisfy this need, a number of inventive methods and apparatus have been developed that facilitate targeting. These methods are described below with respect to one particular type of embodiment, i.e., a portable computing device that is a handheld unit that can be aimed at a remote location by the user. That said, the same methods can be implemented in other physical embodiments, including but not limited to wrist worn embodiments and head mounted embodiments. Also, some embodiments may employ multiple targeting tools that can be used simultaneously or can be selectively switched between. These methods are described in detail below.

The first method involves user of a passive laser pointer. This method enhances a user's ability to target a remote user (or one bounding edge of a group of user) by aiming a laser pointer at the desired target. This method includes a laser pointer within the casing of a targeting portable computing device such that when the portable computing device is held in the hand of the user and aimed at a remote target, the laser pointer shines in the aiming direction and illuminates the currently aimed target with a characteristic laser dot. A button or other user manipulable interface is included upon the portable computing device such that the user can selectively activate the laser pointer. When the laser pointer is activated, the user can see an illuminated dot indicating where the portable computing device is then currently aimed. This illuminated dot serves as a highly valuable reference for the user such that the user can move the portable computing device around in his hand, changing its orientation in space, until the illuminated dot is shining upon the desired target. The user can then press another button (or otherwise interact with the user interface of the portable computer system) to indicate that the desired aiming has been achieved. The portable computing device then reads the position sensors and orientation sensors (and optionally the ranging sensors and/or ranging user input controls) to determine the remote location and/or the range of remote locations that is being targeted by the user at that time. In some embodiments this is a multi-step operation wherein the user targets the bounding edges of a group of users by targeting multiple times at each desired a boundary point.

As shown in FIG. 4, a handheld portable computing device 400 is equipped with a GPS sensor for tracking its position and one or more orientation sensors for tracking the direction that the handheld portable computing device is aimed by the user who is holding it (not shown). Also included and shown is an integrated laser pointer 401 for projecting a red dot 403 upon distant users that fall within the line-of-sight aiming direction of the portable computing device. The laser beam is represented by dotted line 404 and projects as a straight line along the direction of aiming. The user aims the portable computing device at one of five distant users that are visible to the user, using the laser pointier to aid in the aiming process. As shown, these five distant users are members of a social networking service. Each has their own portable computing device local to their person, the portable computing devices are currently in communication with the device 400 through an ad-hoc network enabled by Bluetooth. Each of their portable computing devices is worn on their waist and represented by the drawn black rectangle. One of such portable computing devices is shown as 405 in FIG. 4. Each of these portable computing devices includes a position tracking sensor. In this example the position tracking sensor local to each portable computing device is a GPS transducer integrated within the casing of each portable computing device. Each portable computing device is operative to detect its current position at regular intervals (by accessing the GPS transducer) and reports a representation of its current position to the other of the portable computing devices (including device 400) over the ad-hoc network by following the methods described previously herein. In some embodiments each portable computing device is operative to also report a time-stamp, a velocity, and/or a unique user identifier along with the representation of its current position. The PPCA application on each of the portable computing devices stores the received information in a local locative database that is indexed such that each received position coordinate is correlated with the user and/or portable computing device from which it was received.

As further shown in FIG. 4, the user of the targeting portable computing device 400 (that user not shown), aims the portable computing device at a desired target user. By watching the location of the red dot 403 the targeting user knows where he or she is aiming as he or she changes the orientation of portable computing device 400. Once the portable computing device is aimed at the desired target user 402 which is the forth person from the left in the figure, the targeting user presses a button (or otherwise engages the user interface on the portable computing device). This user-interface step may further include the targeting user pressing an appropriate button or otherwise interacting with the user interface that he or she desires information about the targeted user, desires to initiate communication with the targeted user, or both.

Upon taking such an action, the portable computing device 400 initiates a targeting determination process by following the computational steps outlined previously herein. The first step of the targeting determination process involves portable computing device 400 reading data from a positional sensor such as a GPS sensor at the moment in time when the targeting user pressed the button or otherwise indicated that the portable computing device (or a portion thereof) was properly aimed at the targeted user.

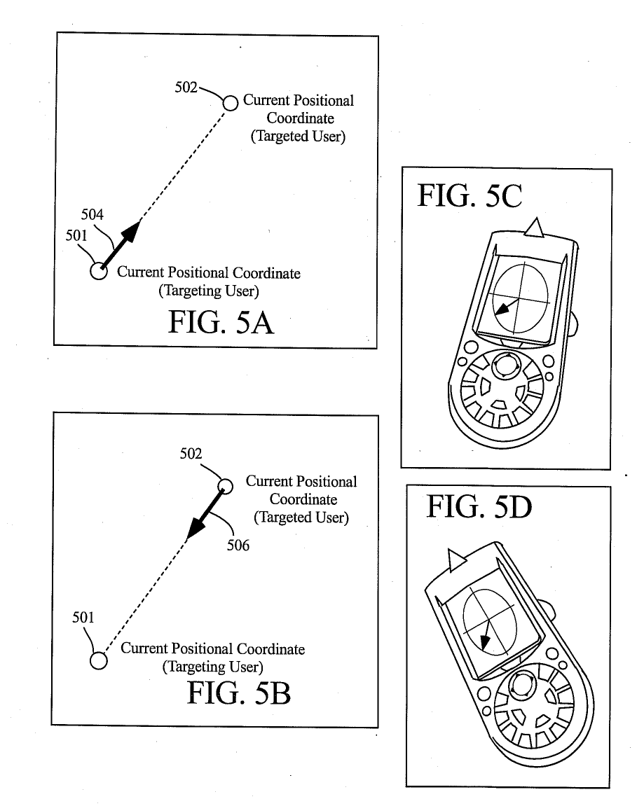

FIGS. 5a-5d illustrate sensor readings according to at least one embodiment of the invention. A sensor reading is performed to derive a current positional coordinate for the targeting user, for example the coordinate 501 shown schematically in FIG. 5a as a shaded circle. Also shown schematically in the figure is the then current location of the targeted user 502 as another shaded circle. The first step of the targeting determination process further involves the portable computing device 400 reading data from one or more orientation sensors such as a magnetometer and/or accelerometer at the moment in time when the targeting user pressed the button or otherwise indicated through the user interface that the portable computing device (or a portion thereof) was properly aimed at the targeted user. This sensor reading is performed to derive a targeting vector for the targeting user that points in the direction from the targeting user to the targeted user such as, for example, the vector 504 shown schematically in FIG. 5a as an arrow. The first step may also further involve the portable computing device reading data from a ranging sensor and/or from a ranging user interface element to derive and/or estimate a distance from the targeting user to the targeted user. In some embodiments of the invention, one or more range values are also determined for each targeting operation. The range values include one or more of an angular range value or a distance range value.

Once the current positional coordinates 501 are determined for the targeting user and a targeting vector 504 is determined as well, values are used by the PPCA of the targeting portable computing device 400. The PPCA uses this information to determine which user(s) are being targeted by the targeting user. Once the targeted user(s) have been determined, information may be exchanged between the targeting portable computing device and the targeted portable computing devices to determine whether or not the targeting user can access information about the targeted user(s) or initiate communication with the targeted user(s). The sub-steps involved in this determination were described in detail above.

If it is determined by the targeting determination process that the targeting user has successfully identified the targeted user through the aiming process and that the targeting user is authorized to access information about the targeted user, the authorized information is transmitted to the portable computing device 400 over a communication link. This information is then displayed to the targeting user on the visual and/or audio display of portable computing device 400. If it is determined by the targeting determination process that the targeting user has successfully identified the targeted user through the aiming process and is authorized to initiate communication with the targeted user, the PPCA of one or both the targeting portable computing device and the targeted portable computing device is further operative to moderate the subsequent communication, optionally maintaining the anonymity of the users involved.

In some embodiments of the present invention, the targeting determination process includes the display of a prompt to the portable computing device of targeted user 402 to inquire if that user explicitly approves or disapproves of the requested information access and/or communication initiation. This process generally causes an alarm (visual, audio, or tactile) to be initiated upon the portable computing device of user 402 to gain that user's attention. This process generally also includes a graphical and/or audio message being then displayed to targeted user 402, the message indicating that the user has been targeted for information access and/or communication initiation and that approval is required. In some embodiments, the PPCA of the targeting user also sends information to the PPCA of the targeted user over the ad-hoc network about the targeting user to facilitate the targeted user's decision as to whether to approve of disapprove and/or the extent of approval. In some embodiments this information includes personal profile information, social networking information, peer-rating data, and/or user popularity data. The targeted user 402 then indicates his or her approval or disapproval or extent of approval by engaging the user interface of her portable computing device.

In some embodiments the PPCA of the targeting user may also communicate locative information to the targeted user indicating the location of the targeting user (or this information may already have been sent as part of background ad-hoc network information exchanges). Using this information, the PPCA of the targeted user may produce a graphical display to inform the user the direction from which he or she was targeted. This is extremely valuable because it allows a targeted user to quickly figure out who has targeted him or her. This information may be derived a user locative vector that points in the direction from the targeted user to the targeting user. Such a vector will generally be the same as the targeting vector derived by the targeting user but will point in the opposite direction. If one or more of the users are in motion, an updated user locative vector may also be computed by the PPCA based upon an updated location of the targeting user and the targeted user. The updated user locative vector will be a vector with a direction that points from the targeted user to the targeting user and can be computed from the current positional coordinates of the targeting user and the current positional coordinates of the targeted user by using common vector mathematics know to the art. This updated user locative vector is computed repeatedly based upon the changing current positional coordinates of the users.

FIG. 5b shows a schematic representation of the spatial coordinates of the targeting user 501 and the targeted user 502. The PPCA of each of the user's portable computing devices as part of the person-to-person communication process disclosed herein generally has access to the current positional coordinates of both users in its respective Local Locative Database. Using such coordinates, the PPCA of each portable computing device can derive a user locative vector that points in the direction from the targeted use to the targeting user by using common vector mathematics know to the art. This user locative vector is shown schematically as arrow 506 in FIG. 5b. If one or more of the users are in motion, this vector is repeatedly computed by the PPCA based upon the updated positional coordinates for the two users.

Upon determining the user locative vector, the PPCA of the portable computing device of the targeted user 402 may optionally display a graphical indication allowing the targeted user to visualize the direction from which he or she was targeted. This can be a graphical line or arrow that indicates the direction which the targeted user should look to see the targeting user. To draw such a graphical line or arrow, the portable computing device of the targeted user performs a number of steps. First, the portable computing device receives the current user locative data from the targeting user over the ad-hoc network. Second, the targeted portable computing device accesses current location data from its own locative sensor. These two sets of locative values are used to derive a vector direction that points from the targeted user to the targeting user using basic vector math. This vector is called the user locative vector. Third, the portable computing device reads data from one or more orientation sensors such as a magnetometer and/or accelerometer within or upon the portable computing device. This sensor reading is used to derive a current orientation vector for the portable computing device indicating the direction in which the user is currently holding the device. Using these two vectors (i.e., the user locative vector and the current orientation vector), the portable computing device can derive the direction in which a graphical line or arrow (or other indicator) should be drawn upon the display of the portable computing device (as it is currently being held by the targeted user) allowing that user to visualize the direction of the targeting user. Such a process is performed by using the current orientation vector as a spatial reference and then drawing the user locative vector relative to the current orientation vector. An example of what would be drawn upon the display of the portable computing device of the targeted user is shown in FIG. 5c. As shown, an arrow is drawn upon the display of the portable computing device of the targeted user, the arrow pointing in the spatial direction of the then current location of the targeting user. In this way the targeted user can turn and look and more easily identify the targeting user. As the targeted user turns his body and thereby changes the current orientation of his or her portable computing device, the current orientation vector changes for the portable computing device. Using updated current orientation vector data, the portable computing device redraws the arrow such that it continues to point in the direction of the current location of the targeting user by accounting for the changed orientation of the targeted user's portable computing device. An example of a redrawn arrow as it might be displayed upon the portable computing device of the targeted user after the targeted user changed the orientation of his or her portable computing device is shown in FIG. 5d. As is seen by comparing FIGS. 5c and 5d, the arrow changes its relative orientation as displayed upon the screen of the portable computing device such that it continues to point in the absolute direction of the targeting user. When the current orientation vector is substantially aligned with the user locative vector, the targeted user is holding their portable computing device such that it is substantially aimed at the targeting user. When this happens (or nearly happens) a visual, aural, or tactile cue may be generated by the portable computing device of the targeted user, the output cue thereby informing the user that his or her portable computing device is then aimed (or substantially aimed, or aimed within a certain range) at the user who just recently targeted him or her. This is an additional way in which the PPCA application may be configured to help a targeted user find the targeted user within his or her surroundings. In some embodiments the visual cue is a graphical element that is drawn brighter upon the screen. In some embodiments the aural cue is an audible beep or alarm or other attention getting sound. The tactile cue may be a vibration.

Referring back to FIG. 4 which shows a laser pointer based targeting tool, it is noted that the portable computing device of the targeting user includes a user interface button or other manipulable interface for turning on the laser pointer at desired times. The user will use this button to turn on the laser pointer only when he or she desires aid in aiming the portable computing device at a desired target. It should also be noted that in many cases the size of the target area is substantially larger than the size of the laser dot displayed by the targeting aid. In some embodiments the targeting aid can also depict the size of the targeting area by displaying multiple dots and/or other projected images.

According to a second method, a digital camera with a display is used. This method enhances a user's ability to target a remote user (or group of users) by including a digital video camera within the casing of the portable computing device such that when the targeting portable computing device is held in the hand of the user and aimed at a remote location, the camera captures an image in the in the aiming direction. The image is displayed upon the screen of the portable computing device. The image depicts that part of the real physical space which is being aimed at by the user. In some embodiments, everything that is displayed upon the screen falls within the range of remote locations being aimed at within the real physical space. In other embodiments, a point (or area) on the image at the center of the screen (or near the center) is that location that is being aimed at in the real physical space. In such embodiments graphical crosshairs can be optionally overlaid upon the displayed image to indicate the point on the image that is being aimed at within the real physical space. In other embodiments a particular area of the image on the screen is the area of locations that is being aimed at in the real physical space. In such embodiments a graphical image depicting the selection area (such as a box or a circle or a shaded region) may be optionally overlaid upon the displayed image to indicate the area on the image that is being aimed at within the real physical space.

The size of the selection area (e.g., the size of the box or circle or shaded region) can be optionally controlled by the user through the user interface on the portable computing device. By changing the size of the selection area, the user can change the size of the target area for which user-information and/or user-communication initiation is requested. For example, if the user sets the size of the area to be large, a large angular range and/or distance range is used by the PPCA when targeting a remote user (or group of users). On the other hand, if the user sets the size of the area to be small, a small angular range and/or distance range is used by PPCA when targeting. In this way, if the user sets the size of the selection area to be large, the PPCA targets users within a larger area than if the user sets the size of the selection area to be small.

A button or other user manipulable interface is included upon the portable computing device such that the user can selectively activate the digital camera such that the image of the targeted area currently being aimed at is displayed. This displayed image serves as a valuable reference for the user such that the user can move the portable computing device around in his hand, changing its orientation in space, until the image includes the desired target user(s). The user can then press another button (or otherwise interact with the user interface of the portable computer system) to indicate that the desired aiming has been achieved. The portable computing device then reads the position sensors and orientation sensors (and optionally the ranging sensors and/or ranging user input controls) to determine the targeting vector, targeting coordinates, and/or range values for the current targeting action.

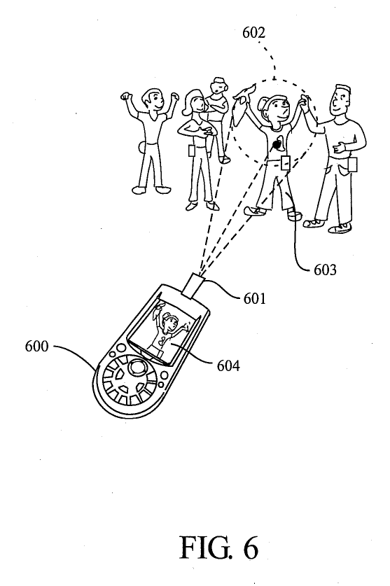

FIG. 6 illustrates a portable computing device equipped with a GPS sensor for tracking its position and one or more orientation sensors for tracking its direction as aimed by a user according to at least one embodiment of the invention. Also shown is an integrated digital video camera 601 for capturing a line-of-sight image in the direction that the portable computing device is aimed by the user. The dotted lines 603 indicate the field of view of the camera as determined by the optics and how the portable computing device is aimed by the user. The captured image 604 is displayed upon the screen of the portable computing device showing the user what is being aimed at and thereby assisting in the targeting process. Cross hairs and/or other graphics (not shown) may be overlaid upon the displayed image to assist the user in accurate targeting. In this FIG. the user aims the portable computing device at one of five users that are visible to the targeting user, using the displayed image captured by the camera to aid in the aiming process. By watching the displayed image the targeting user knows where he is aiming the portable computing device as he or she changes the orientation. Once the portable computing device is aimed at the desired target 602 which is the forth person from the left in the figure, the user presses a button (or otherwise engages the user interface on the portable computing device) to either (a) request information about that person, (b) request communication initiation with that person, or (c) both request information about that person and request communication initiation with that person. Upon engaging the user interface as such, the portable computing device of the targeting user is operative to perform the targeting steps described previously. If it is determined by the targeting determination process that the targeting user has successfully identified the targeted user through the aiming process and that the targeting user is authorized to access information about the targeted user, the authorized information is accessed by the PPCA of the targeting portable computing device from the targeted portable computing device over the ad-hoc network. This information is then displayed to the targeting user on the visual and/or audio display of portable computing device 600. If it is determined by the targeting determination process that the targeting user is not authorized to access information about the targeted user, a message is displayed to the targeting user informing him or her that authorization was denied.

If it is determined by the targeting determination process that the targeting user has successfully identified the targeted user through the aiming process and is authorized to initiate communication with the targeted user, the PPCA of one or both the targeting and targeted portable computing device is further operative to moderate the subsequent communication, optionally maintaining the anonymity of the users involved. If it is determined by the targeting determination process that the targeting user is not authorized to initiate communication with the targeted user, a message is displayed to the targeting user informing him or her that communication initiation was denied.

In some embodiments, moderating the communication between the targeting user and the targeted user(s) is be achieved by the ad-hoc network routing one or more communication message(s) between the targeting user and the targeted user(s). In many embodiments the network transmits such messages while masking personally identifying information thereby preserving user anonymity of one or both users. In such embodiments a user may communicate without the other user gaining access to that user's phone number, email address, name, alias, or other person ID information that could be used to initiate communication again in the future. In other embodiments, moderating communication between the targeting user and the targeted user(s) is achieved by sending data to the targeting user enabling that user to communicate directly with the targeted user(s) outside the ad-hoc network. In some such embodiments this is achieved in whole or in part by the targeted portable computing device sending a phone number, email address, instant messaging address, alias, or other similar identifier about the targeted user to the targeting user so that the targeting user can initiate communication with the targeted user.

An optical and/or digital zoom feature (not shown) can be employed within the digital camera embodiment described in the paragraphs above. Such an optical and/or digital zoom can allow the user to zoom-in or zoom-out with the camera and thereby change the field of view displayed upon the screen. By changing the displayed field of view by adjusting the optical and/or digital zoom, the user changes the range of distant location values and/or the range of targeting vector angles for which information is requested. For example, if the user zooms out, a large range of values are used by PPCA as part of the targeting process. If the user zooms-in, however, a small range of values is used by the PPCA as part of the targeting process. That is, if the user zooms-out, the software targets users within a larger spatial area than if the user zooms-in.

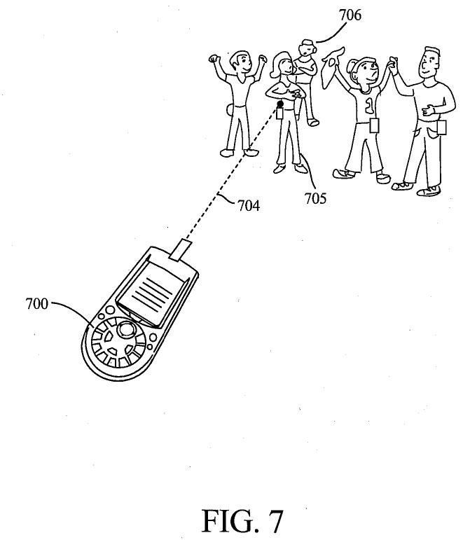

Embodiments of the invention sometimes deal with multiple users who fall on or near a targeting vector. When the user aims the portable computing device in a particular direction, the targeting vector may point at or near multiple users, many of which the targeting user is not interested. For embodiments that do not include ranging hardware and therefore do not specify a target distance, it may not be clear which of the plurality of users the targeting user is intending to aim at, especially if they fall at different distances but equally close to the target vector. To address this problem, many embodiments of the present invention are configured such that when a plurality of users fall on or near the targeting vector (as determined by the PPCA during the targeting determination process), the PPCA selects the nearest user to the targeting user based upon the line of sight distance between the current positional coordinates of the targeting user and the current positional coordinates of the users being aimed at. In this way the PPCA selects the user who is most nearest in the foreground as viewed by the targeting user when multiple distant users fall on or near the same targeting vector. This is made clear with respect to FIG. 7.

FIG. 7 illustrates a portable computing device 700 aimed by a targeting user in a particular direction according to at least one embodiment of the invention. The resulting targeting vector is the direction depicted as dotted line 704. As shown, a plurality of users fall on or near the targeting vector, including user 705 and user 706. To deal with this ambiguity, the PPCA is configured as part of the targeting determination process, to identify the user who is nearest to the targeting user as the targeted user. This may be performed through simple vector mathematics. In one embodiment this is achieved using the current positional coordinates of the targeting user and the current positional coordinates of each of the distant users who fall within a certain range of the targeting vector and computing which of the distant users is nearest to the targeting user. In FIG. 7, this is user 705 for she resides nearer to the targeting user than user 706 at the time of targeting. In this way ambiguity is resolved. This allows a user to target a distant user in a crowded area and know that the nearest distant user will be targeted.

To further specify which of a plurality of distant users a targeting user is aiming at, the targeting user may use his or her user interface to specify a TARGET USER TYPE as a means of more clearly specifying which type of user the user is trying to aim at within a crowded spaced. A defined herein, TARGET USER TYPE may include any piece of information that may be included in a user's personal profile information and/or social networking information. For example, the TARGET USER TYPE may simply specify the intended gender of the targeted user. If the targeting user specified MALE as the TARGET USER TYPE, the PPCA would then perform the targeting determination process to select the nearest user of the plurality of users who fall on or near the targeting vector who is MALE as indicated by the stored personal profile information for that user. In this way, the targeting user in the example depicted in FIG. 7 could cause the PPCA to select use 706 and not user 705 as the targeted user. Thus the added parameter of a TARGET USER TYPE is helpful in allowing a targeting user to more clearly specify which user from among a plurality of users that user is trying to target.

Similarly, a targeting user may point his or her portable computing device at a large crowd and set range values to encompass a large number of distant users. The targeting user may also set the TARGET USER TYPE to include social networking parameters that specify only users who are friends of the targeting user or friends-of-friends of the targeting user. In this way the user may quickly identify from among a large crowd of distant individuals which ones, if any, are friends or friends-of-friends.

A targeting user may point his or her portable computing device at a large crowd and set range values to encompass a large number of distant users. The targeting user may also set the TARGET USER TYPE to include personal profile parameters that specify only users who are students at a particular school. In this way the user may quickly identify from among a large crowd of distant individuals which ones, if any, are students of a particular school.

Similarly, a targeting user may point his or her portable computing device at a large crowd and set range values to encompass a large number of distant users. The targeting user may also set the TARGET USER TYPE to include personal profile parameters that specify only users who are employees of a particular organization. In this way the user may quickly identify from among a large crowd of distant individuals which ones, if any, are employees of a particular organization.

A targeting user may also point his or her portable computing device at a large crowd and set range values to encompass a large number of distant users. The targeting user may also set the TARGET USER TYPE to include personal profile parameters that specify only users who are a particular gender (e.g., FEMALE) and who fall within a particular age range (e.g., 25 to 35) and who have a political affiliation (e.g., members of the Democratic party). In this way the user may quickly identify from among a large crowd of distant individuals which ones, if any, are females between the ages of 25 to 35 who are democrats. In this way a particular combination of characteristics can be set by a targeting user when performing a targeting operation.

An additional tool that may be used for specifying which user from among a plurality of users fall on or near a particular targeting vector is a manual roller such as the roller 205 shown in FIG. 2. The targeting user may use the roller to scroll from near to far (or far to near) along the targeting vector, as a means of selecting users of increasing (or decreasing) distance from the targeting user along the targeting vector.

Another aspect of the present invention enabling efficient information access about a large group of targeted users (as opposed to an individual targeted user or a small group of targeted users) that employs the same technical infrastructure as disclosed herein is referred to herein as “Demographic Scanning.” In this feature a targeting user points his portable computing device in a particular direction and thereby specifies a particular area in the spatial environment that includes a large group of users about which he or she desires demographic information. For example, the user may point his or her portable computing device at the location of a particular street-side cafe that the user is considering entering while walking down the street. Using the methods and apparatus as disclosed previously herein, the user also specifies through the user interface of his or her portable computing device that he or she desires to receive a Demographic Scan about the specified targeted area and may specify particular demographic characteristics that he or she is interested in. The PPCA then accesses the local locative database, determines which users fall within the specified target area, and tallies the users based upon each of the particular demographic characteristics. These demographic characteristics are subsequently reported to the targeting user as a statistical profile. These demographic characteristics may include, for example, an indication of the gender makeup, age makeup, political party makeup, professional makeup, education level makeup, and/or sports-team partiality makeup, marital status makeup, of the group of users within or near the specified area. In this way, the targeting user may decide if this particular cafe is desirable to him or her. For example, the user may be looking for an establishment that has a high percentage or quantity of single women who have college degrees. Thus, he can point at the area and request a demographic scan using the characteristics of gender, marital status, and highest level of education. The PPCA, in response to such a request, will report a statistical profile of target users based upon these characteristics. Alternately, the user may be looking for a target group of people that has a high percentage of Dodger fans. Thus, he can point at a group of people and request a demographic scan using the characteristics of baseball team partiality. The PPCA, in response to such a request, will report a statistical profile of target users based upon this characteristics. Alternately, the user may be looking for an establishment that has a high percentage of people who are affiliated with a particular school, a particular hobby, and/or a particular profession. Thus, he can point at the group of people and request a demographic scan using the characteristics of school affiliation, hobby, and/or profession. The PPCA, in response to such a request, will report a statistical profile of target users based upon one or more of these characteristics. In this way the demographic scanning feature of the present invention enables a user to gain insights about the demographic makeup of group of distant users.

As described herein, a user may wish to define a group of users by specifying an area within which those users currently reside. This may be achieved in a variety of ways as described previously herein. One method employs a multi-step targeting method in which the user specifies two targeting vectors that bound an angular targeting region. The targeting user of portable computing device points the portable computing device (or a portion thereof) at one edge of a bounding angular region and engages the user interface on the device to specify that first edge. Upon engaging the user interface, position and orientation data for the portable computing device are captured from sensors. The targeting user then points the portable computing device (or a portion thereof) at a second edge of a bounding angular region and engages the user interface on the device to specify that second edge. Upon engaging the user interface, position and orientation data for the portable computing device are captured from sensors. The PPCA application then uses the defined bounded area in determining the target users. The targeting user may also specify through the user interface of the portable computing device if he or she desires to gain information about this group of users, initiate communication with this group of users, or both. When gaining information about this group of users, the user may request that the information be presented as demographic statistics that indicate the demographic makeup of the group (with respect to specified criteria) as described with in the demographic scanning section above. For example, the targeting user may ask for demographic statistics about the gender makeup of the group by selecting appropriate choices upon the user interface menus of the portable computing device. The PPCA responds in accordance with such a request from the targeting user, computing and reporting, for example, that 40% of the targeted group is female and 60% of the targeted group is male. This data is presented to the targeting user upon the display of his or her portable computing device.

In some embodiments the portable computing device with the user aiming portion may include an image projector, and the image projector may be configured to project a visual image in the direction of the user aiming portion. In some such embodiments the image projector is configured to project information in a visual form upon the user being pointed at or upon a surface immediately proximal to the user being pointed at. In a common embodiment the information that is projected in visual form is ID information and/or profile information about the user being pointed, the information being received by the portable computing device over a communication network and in response to the pointing initiated communication process disclosed herein. For example, the user's name may be projected visually upon the user being pointed at. In one such embodiment the user's name is projected upon the shirt of the user being pointed at. Similarly, profile information about the user being pointed at, for example the user's age, gender, and/or group affiliation, may be projected upon the user being pointed at. In other embodiments, graphical overlays are projected upon the user being pointed at, for example an enhanced graphical outline of the user may be projected upon the user being pointed at. In some embodiments the image being projected upon the user is a processed version of a live image of the user that has been captured by a camera within the portable computing device. For example, a color-shifted image of the user may be projected back upon the user, thereby visually accentuating the user within the visual field. Technical details about how an image projector may be incorporated within a portable computing device and project aimable images upon local objects is disclosed within co-pending provisional application by the present inventor with Ser. No. 60/759,530 and filing date Jan. 17, 2006. The aforementioned provisional application is hereby incorporated by reference in its entirety.

This invention has been described in detail with reference to various embodiments. It should be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art.

Other embodiments, combinations and modifications of this invention will occur readily to those of ordinary skill in the art in view of these teachings. Therefore, this invention is not to be limited to the specific embodiments described or the specific figures provided. This invention has been described in detail with reference to various embodiments. Not all features are required of all embodiments. It should also be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art. Numerous modifications and variations could be made thereto by those skilled in the art without departing from the scope of the invention set forth in the claims.

What is claimed is:

1. A system for pointing-initiated person-to-person communication comprising:
a first portable computing device operated by a first user, the first portable computing device including a first location sensor, an orientation sensor, a user aiming portion, and a first wireless communication link, the first wireless communication link enabling an establishment of at least one ad hoc network with other enabled portable computing devices within a local proximity of the first portable computing device;
a plurality of second portable computing devices, each of the second portable computing devices including a second location sensor and a second wireless communication link, the second wireless communication link enabling the establishment of at least one ad-hoc networks with other enabled portable computing device within a local proximity of the second portable computing device;
targeting routines running on the first portable computing device for performing a targeting determination as to whether the user aiming portion of the first portable computing device is aimed substantially at a particular second portable computing device, the targeting determination being performed at least in part based on a substantially current location value of the first portable computing device, a substantially current aiming orientation value of the first portable computing device, and substantially current locative data indicating a location of the particular second portable computing device, the locative data being received by the first portable computing device from the particular second portable computing device over an intervening ad hoc network; and
communication routines running on at least one of the first portable computing device and the particular second portable computing device for enabling person-to-person communication between the first user of the first portable computing device and a second user of the particular second portable computing device, the enabling being performed in response to the targeting determination being affirmative.

2. The system of claim 1 wherein at least one of the first location sensor and the second location sensor is a GPS transducer.

3. The system of claim 1 wherein the orientation sensor includes a magnetometer.

4. The system of claim 1 wherein location data for each of the plurality of second portable computing devices is repeatedly received by the first portable computing device over the intervening ad-hoc network.

5. The system of claim 1 wherein profile information associated with at least one of the first portable computing device and the first user is sent to the particular second portable computing device in response to the targeting determination being affirmative.

6. The system of claim 5 wherein a representation of the profile information is displayed upon a display of the particular second portable computing device.

7. The system of claim 6 wherein the profile information includes an indication of the relative location of the first portable computing device with respect to the particular second portable computing device.

8. The system of claim 1 wherein the second user of the particular second portable computing device is required to affirmatively accept person-to-person communication with the first portable computing device by entering input into the second portable computing device in order to enable real-time person-to-person voice communication between the first portable computing device and the particular second portable computing device.

9. The system of claim 1 wherein the targeting routines perform mathematical operations that determine whether a vector starting from a first spatial location of the first portable computing device and extending in a direction of the user aiming portion is within a certain proximity of a second spatial location of the particular second portable computing device.

10. The system of claim 9 wherein the direction of the aiming portion is a direction of the aiming portion at a time corresponding substantially with when the first user engages a targeting user interface of the first portable computing device.

11. The system of claim 10 wherein the targeting user interface is a button upon the first portable computing device.

12. The system of claim 9 wherein the targeting routines determine whether a vector starting from the first spatial location of the first portable computing device and extending in a direction of the aiming portion comes closer to the second spatial location of the particular second portable computing device than to other second portable computing devices of the plurality of second portable computing devices.

13. The system of claim 1 wherein an enabled person-to-person communication includes a bidirectional voice conversation transmitted over a wireless network.

14. The system of claim 1 wherein an enabled person-to-person communication includes a text message transmitted over a wireless network from the first portable computing device to the particular second portable computing device.

15. A method of providing pointing initiated person-to-person communication, comprising:
detecting a location and pointing orientation of a first portable computing device of a first user, the pointing orientation being associated with an aiming portion of the first portable computing device;
receiving substantially current location data for a second portable computing device over an intervening ad-hoc network, the second portable computing device being associated with a second user;
determining, using at least the detected location and pointing orientation of the first portable computing device and the received location data of the second portable computing device, whether the second portable computing device was substantially pointed at by the aiming portion of the first portable computing device; and
communicating a message from the first user of the first portable computing device to a second user of the second portable computing device in response, at least in part, to the determining.

16. The method of claim 15 wherein the second portable computing device is determined to be substantially pointed at in response to its location data falling within at least one of a defined mathematical area and volume extending approximately from the first portable computing device in a direction of the aiming portion.

17. The method of claim 16 wherein the at least one of the area and volume is at least one of approximately wedge-shaped and cone-shaped.

18. The method of claim 15 wherein the determining is performed at least in part in response to the first user engaging a targeting user interface of the first portable computing device.

19. The method of claim 18 wherein the engaging a targeting user interface comprises the first user manually engaging a control of the first portable computing device in response to the first portable computing device being desirably aimed.

20. The method of claim 19 wherein the control is a button.

21. The method of claim 15 wherein the determining includes an assessment that the second portable computing device is closer to the first portable computing device than a third portable computing device is to the first portable computing device.

22. The method of claim 15 wherein the determining includes an assessment that the second portable computing device is closer to a mathematical vector extending from the first portable computing device in an aiming direction than a third portable computing device is to the mathematical vector.

23. A method of providing pointing initiated person-to-person communication, comprising:
detecting a first location and pointing orientation of a first portable computing device of a first user, the pointing orientation being associated with an aiming portion of the first portable computing device;
detecting a second location of a second portable computing device;
determining, using the detected location and orientation of the first portable computing device and at least one piece of locative data communicated between the first portable computing device and the second portable computing device over an ad-hoc network, whether the first portable computing device has successfully targeted the second portable computing device through a pointing of an aiming portion of the first portable computing device at the second portable computing device; and
initiating communication between the first user of the first portable computing device and a second user of the second portable computing device at least in part in response to the determining being affirmative.

24. The method of claim 23 wherein the first portable computing device is determined to have successfully targeted the second portable computing device at least in part based upon a location value associated with the second portable computing device falling within at least one of a mathematical area and volume extending approximately from the first portable computing device in a direction of the aiming portion.

25. The method of claim 24 wherein the at least one of area and volume is at least one of approximately wedge shaped and cone shaped.

26. The method of claim 23 wherein the determining is performed at least in part in response to the first user engaging a targeting user interface of the first portable computing device.

27. The method of claim 26 wherein the engaging a targeting user interface comprises the first user manually engaging a control of the first portable computing device in response to the first portable computing device being desirably aimed.

28. The method of claim 23 wherein the ad-hoc network is a Bluetooth network.

29. The method of claim 23 wherein the initiated communication includes a bi-directional voice conversation transmitted over a wireless network.

30. The method of claim 23 wherein the initiated communication includes a text message transmitted over a wireless network.

31. The method of claim 23 wherein a screen of the second portable computing device displays information indicating the approximate relative direction of the first portable computing device
